(19) United States
(12) Patent Application Publication
(10) Pub. No.: US 2026/0238672 A1
(43) Pub. Date: Aug. 13, 2026

(54) SYSTEMS AND METHODS FOR LARGE LANGUAGE MODEL BASED TECHNICAL RISK AND ARCHITECTURAL ANALYSIS

(71) Applicant: JPMORGAN CHASE BANK, N.A., New York, NY (US)

(72) Inventors: Conor MCGOUGH, Taunton (GB); Sean CAVANAGH, Yardley, PA (US); Juan MORA, Irving, TX (US); Garry HAMILTON, London (GB); Lavesh GAJJAR, Herts (GB)

(21) Appl. No.: 19/180,977

(22) Filed: Apr. 16, 2025

Related U.S. Application Data
(60) Provisional application No. 63/634,786, filed on Apr. 16, 2024.

(51) Int. Cl. H04L 9/40; H04L 41/16

(52) U.S. Cl. CPC H04L 63/1433; H04L 41/16; H04L 63/20

(57) ABSTRACT

A method may include: a computer program (1) generating, using a large language model (LLM), a threat catalog comprising a plurality of threats; (2) categorizing, using the LLM, the threats into a plurality of threat categories according to a threat categorization definition; (3) de-duplicating, using the LLM, the threats within each threat category; (4) determining, using the LLM, based on a description of a technology, a use case, and an architecture, risk scenarios based on the threat catalog; (5) determining, using the LLM, an inherent risk for each of the risk scenarios; (6) identifying, using the LLM, risk treatment measures to reduce the inherent risk for each of the risk scenarios; (7) categorizing, using the LLM, a residual risk for each of the risk scenarios after the risk treatment measures; and (8) applying one of the risk treatment measures, based on the residual risk.

### RELATED APPLICATIONS

This application claims priority to, and the benefit of, U.S. Provisional Patent Application Ser. No. 63/634,786, filed Apr. 16, 2024, the disclosure of which is hereby incorporated, by reference, in its entirety.

### BACKGROUND OF THE INVENTION

### 1. Field of the Invention

Embodiments relate to systems and methods for large language model based technical risk and architectural analysis.

### 2. Description of the Related Art

In the rapidly evolving landscape of emerging technologies, conducting comprehensive risk assessments has become both a critical necessity and a significant challenge. Traditional risk assessment methods are often manual, time-consuming, and costly, making it difficult for organizations to keep pace with the speed of technological change. Furthermore, these methods may not fully capture the unique risks associated with emerging technologies, leading to potential gaps in risk identification and mitigation.

### SUMMARY OF THE INVENTION

Systems and methods for large language model based technical risk and architectural analysis are disclosed. According to an embodiment, a method may include: (1) generating, by a computer program and using a large language model (LLM), a threat catalog comprising a plurality of threats; (2) categorizing, by the computer program and using the LLM, the threats into a plurality of threat categories according to a threat categorization definition; (3) de-duplicating, by the computer program and using the LLM, the threats within each threat category; (4) determining, by the computer program and using the LLM, based on a description of a technology, a use case, and an architecture, risk scenarios based on the threat catalog; (5) determining, by the computer program and using the LLM, an inherent risk for each of the risk scenarios; (6) identifying, by the computer program and using the LLM, risk treatment measures to reduce the inherent risk for each of the risk scenarios; (7) categorizing, by the computer program and using the LLM, a residual risk for each of the risk scenarios after the risk treatment measures; and (8) applying, by the computer program, one of the risk treatment measures, based on the residual risk.

In one embodiment, the threat catalog is generated from industry documentation, known risk and migrations, industry standards and best practices, and/or known regulatory requirements.

In one embodiment, the deduplication creates a new threat, updates an existing threat, or splits the existing threat into multiple threats.

In one embodiment, the LLM returns an explanation for creating the new threat, updating the existing threat, or splitting the existing threat into multiple threats.

In one embodiment, each threat in the threat catalog is tagged with a threat tactic and a threat technique.

In one embodiment, each of the risk scenarios is tagged with a Common Attack Pattern Enumeration and Classification tag.

In one embodiment, the inherent risk is based on a likelihood of a risk scenario occurring and an impact of the risk scenario.

In one embodiment, the risk treatment measures are identified from one or more third party source.

In one embodiment, the risk treatment measures may include security recommendations, managing vulnerabilities, compliance monitoring, and incident response automation.

In one embodiment, the risk treatment measures may include automatically adjusting access control settings based on user behavior analysis and performing network segmentation.

According to another embodiment, a non-transitory computer readable storage medium may include stored thereon, which when read and executed by one or more computer processors, cause the one or more computer processors to perform steps comprising: generating, using a large language model (LLM), a threat catalog comprising a plurality of threats; categorizing, using the LLM, the threats into a plurality of threat categories according to a threat categorization definition; de-duplicating, using the LLM, the threats within each threat category; determining, using the LLM and based on a description of a technology, a use case, and an architecture, risk scenarios based on the threat catalog; determining, using the LLM, an inherent risk for each of the risk scenarios; identifying, using the LLM, risk treatment measures to reduce the inherent risk for each of the risk scenarios; categorizing, by using the LLM, a residual risk for each of the risk scenarios after the risk treatment measures; and applying one of the risk treatment measures, based on the residual risk.

In one embodiment, the threat catalog is generated from industry documentation, known risk and migrations, industry standards and best practices, and/or known regulatory requirements.

In one embodiment, the deduplication creates a new threat, updates an existing threat, or splits the existing threat into multiple threats.

In one embodiment, the LLM returns an explanation for creating the new threat, updating the existing threat, or splitting the existing threat into multiple threats.

In one embodiment, each threat in the threat catalog is tagged with a threat tactic and a threat technique.

In one embodiment, each of the risk scenarios is tagged with a Common Attack Pattern Enumeration and Classification tag.

In one embodiment, the inherent risk is based on a likelihood of a risk scenario occurring and an impact of the risk scenario.

In one embodiment, the risk treatment measures are identified from one or more third party source.

In one embodiment, the risk treatment measures may include security recommendations, managing vulnerabilities, compliance monitoring, and incident response automation.

In one embodiment, the risk treatment measures may include automatically adjusting access control settings based on user behavior analysis and performing network segmentation.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for large language model based technical risk and architectural analysis according to an embodiment;

FIG. 2 illustrates a method for large language model based technical risk and architectural analysis according to an embodiment;

FIG. 3 depicts an exemplary computing system for implementing aspects of the present disclosure.

### DETAILED DESCRIPTION OF PREFERRED EMBODIMENTS

Embodiments are generally directed to systems and methods for large language model based technical risk and architectural analysis. In one embodiment, the risk assessment may be for new, emerging technologies. In other embodiments, the risk assessment may be for existing technologies.

Embodiments may leverage Large Language Models (LLMs) to streamline and enhance the suitability assessment, evaluation, and risk assessment process for technology solutions. Embodiments may use generic and/or specifically trained models to enable proactive risk management and provide assistance in making informed decisions to ensure the security and reliability of technology products.

Embodiments may use techniques, such as Retrieval Augmented Generation, to aid in engineering effective prompts based on a methodology for interacting with LLMs for this purpose. For example, the LLM may be provided with text representations of solution architectures, industry documentation and white papers, known risks and mitigations, risk and control frameworks and any use case specific documentation, and may produce a fully fledge risk/suitability report as output. Example output sections may include Inherent threat identification, vulnerability identification, impact analysis, risk determination, control identification and residual risk, risk aggregation, summary and recommendation.

Leveraging large language models not only vastly speeds up a manual process, but also makes the process and analysis much more scientific, more repeatable, and enables huge amounts of the latest data to be taken into account which is very impactful to time to market and enabling innovation.

Embodiments may also present the model with text-based representation of solution architecture diagrams. This is inherently different from other projects that rely on the model to interpret diagrams directly. Thus, embodiments may convert architectural diagrams into a human readable text-based syntax for the model, which may be optimized for natural language processing.

Embodiments may provide the following features:

1. Control Gap Identification: The LLM may be provided with solution summaries and asked to identify control gaps based on public and internal control standards. Thus, the model may understand control standards and may apply them to specific solutions.

2 Risk Analysis: The LLM may be provided with a range of risk data, including raw solution summaries, Security Architecture Reviews (SARs), and partial and complete risk analyses. The model may be asked to perform a risk analysis based on this data, to summarize and categorize the risks based on different frameworks (like NIST and CORE), and suggest possible compensating controls, mitigants, and alternative implementations. Thus, the model may process and analyze complex risk data, apply risk frameworks, and generate actionable recommendations.

3. Threat Identification: The model may be used to supplement existing threat identification processes, and to derive itself based off industry practice and frameworks such as MITRE ATT&CK. As used herein, a threat may include: any circumstance or event with the potential to adversely impact organizational operations (including mission, functions, image, or reputation), organizational assets, individuals, other organizations, or the Nation through an information system via unauthorized access, destruction, disclosure, modification of information, and/or denial of service. Examples of threats include trojan horse attacks, phishing attacks, insider threats, natural disasters, etc. Threats may be mapped to one or more MITRE ATT&CK techniques, which are techniques adversaries may use to exploit the threat.

4. Recommendation Generation: The model may be asked to provide an overall stance and recommendation on whether or not to proceed with a given solution based on its risk analysis. The model may synthesize its analysis into a clear and concise recommendation.

5. Vendor Documentation Analysis: The model may be provided with vendor documentation, SOC 2 reports, Third Party Oversight (TPO) engagements, legal contracts, etc., and may be asked to summarize and consolidate this into an overall risk view. Thus, the model may process and analyze diverse types of documentation and generate a comprehensive risk view.

6. Specific Question Answering: The LLM may be provided with vendor documentation, and asked to answer specific questions, such as “Does the SOC 2 or legal contract offer any mitigants to outdated encryption protocols?” Thus, the model may extract specific information from complex documents and apply it to specific questions.

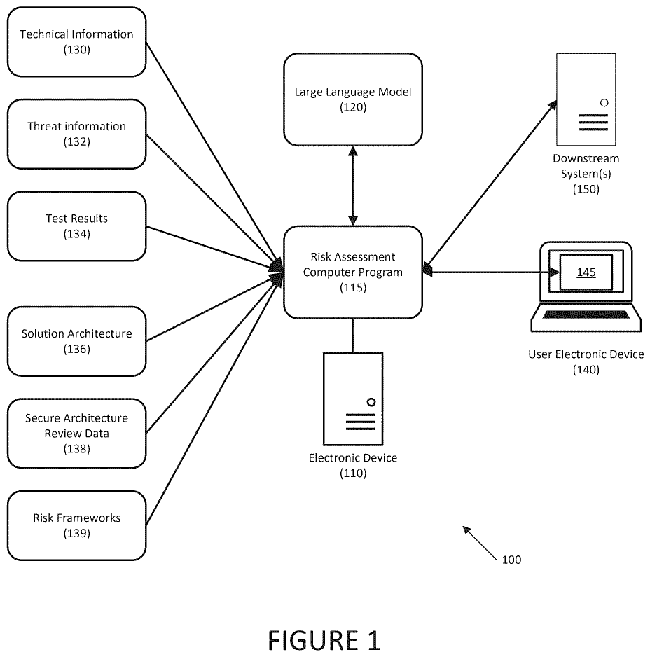

Referring to FIG. 1, a system for large language model based technical risk and architectural analysis is provided according to an embodiment. System 100 may include electronic device 110, which may be a server (e.g., physical and/or cloud based), a computer (e.g., workstation, desktop, laptop, notebook, tablet, etc.), etc. In one embodiment, electronic device 110 may execute risk assessment computer program 115 that may receive data from data sources, define a solution, covert the solution into text embeddings, perform similarity searching per threat domain or a threat dataset, provide large language model (LLM) 120 with the most relevant threats and a full solution definition, and gather threats from the domain that are most relevant to the solution.

Risk assessment computer program 115 may receive input from a variety of sources, including technical information 130, threat information 132, system test results 134 (e.g., penetration testing results), solution architecture data 136, secure architecture review data 138, risk frameworks 139, etc. These artifacts and data are crucial for ensuring that a system is well-designed, secure, and capable of meeting its intended goals. They provide a comprehensive view of the system's architecture and security posture, facilitating better decision-making and risk management, so are ideal inputs for our invention.

Examples of technical information 130 may include technical documentation, text summary of threat assessment meetings, etc.

Examples of threat information 132 may include real-time security operations data streams, real-time threat intelligence data, threat operations data analysis, a threat catalog, etc.

An example of system test results 134 is penetration testing results.

Examples of solution architecture data 136 may include architecture diagrams that provide visual representations of the system's structure, including components, interactions, and data flow, requirements specifications that detail the functional and non-functional requirements of the system, use case diagrams that provide illustrations of interactions between users and the system, data models such as schematics that define how data is structured and related within the system, component specifications that provide detailed descriptions of each component within the architecture, including their responsibilities and interfaces, deployment diagrams, such as visuals showing how software components are deployed on hardware nodes, integration plans that outline how different system components will be integrated and interact with each other, technology stack documentation that provides information about the technologies and tools used in the solution, etc.).

Examples of secure architecture review data 138 may include threat model that provides an analysis of potential threats to the system and how they can be mitigated, security requirements, such as any specific security needs that the system must meet, often derived from regulatory standards or best practices, vulnerability assessments, such as reports identifying potential vulnerabilities in the system, access control policies, such as documentation of how access to different parts of the system is controlled and managed, encryption standards, such as details on how data is encrypted both at rest and in transit, audit logs, such as records of system activity that can be reviewed for security incidents, incident response plans, such as procedures for responding to security breaches or other incidents, compliance checklists, such as lists off regulatory or industry standards that the system must comply with, etc.

In technology risk management, various risk frameworks 139 and models may be used to identify, assess, and manage risks. These risk frameworks provide structured approaches to understanding and mitigating risks associated with technology systems. Examples of risk frameworks may include CAPEC (Common Attack Pattern Enumeration and Classification), which is a comprehensive dictionary and classification taxonomy of known attack patterns that helps organizations understand the methods attackers use to exploit vulnerabilities in software and systems; MITRE ATT&CK (Adversarial Tactics, Techniques, and Common Knowledge), which is a globally accessible knowledge base of adversary tactics and techniques based on real-world observations that is used to develop threat models and methodologies in the cybersecurity community; NIST Cybersecurity Framework that provides a policy framework of computer security guidance for how private sector organizations can assess and improve their ability to prevent, detect, and respond to cyber-attacks, ISO/IEC 27001 that provides a systematic approach to managing sensitive company information so that it remains secure; COBIT (Control Objectives for Information and Related Technologies), is a framework for developing, implementing, monitoring, and improving IT governance and management practices that helps organizations create optimal value from IT by maintaining a balance between realizing benefits and optimizing risk levels and resource use, OWASP (Open Web Application Security Project), that provides a variety of resources, including the OWASP Top Ten, which is a standard awareness document for developers and web application security, FAIR (Factor Analysis of Information Risk), that provides a framework for developing a risk management program, ITIL (Information Technology Infrastructure Library), a set of practices for IT service management (ITSM) that focuses on aligning IT services with the needs of the business that provides a comprehensive framework for identifying, planning, delivering, and supporting IT services, CIS Controls (Center for Internet Security Controls), a set of best practices for securing IT systems and data against the most pervasive attacks.

LLM 120 may be any suitable LLM that may receive queries from risk assessment computer program 115. For example, risk assessment computer program 115 may provide LLM 120 with context (e.g., data from one or more of data sources 130, 132, 134, 136) and a prompt, and may return the requested information. Examples of prompts may include a prompt to generate potential risk scenarios based on threat information, a prompt for an impact and likelihood analysis of the risk scenarios, such as a risk score), a prompt for treatment measures to reduce the risk (e.g., impact and/or likelihood) of the risk scenarios, a prompt for an impact and likelihood analysis of the risk scenarios that may be combined into a residual (after risk treatment) risk score for each scenario, a prompt for aggregated results, thematic gap analysis/anomaly identification, risk treatment prioritization, etc.

Risk scenarios may be categorized by risk type: Threats may be identified as applicable to a solution under the context of their risk type, in the form of a risk scenario. They are combinations of threats and techniques that are specific to the technology solution being assessed.

System 100 may further include user electronic device 140 that may execute user computer program 145. User electronic device 140 may be a computer (e.g., a workstation, a desktop, a laptop, a notebook, a tablet, etc.), a smart device (e.g., smart phone, smart watch, etc.), an Internet of Things appliance, etc. User computer program 145 may interface with risk assessment computer program 115 to identify prompts for LLM 120, and to receive responses from LLM 120.

System 100 may further include one or more downstream systems 150 that may implement any security recommendations identified by risk assessment computer program 115. Examples of security recommendations may include providing real-time threat detection and response (e.g., automatically identify and respond to security threats, such as unauthorized access attempts or malware infections, by isolating affected systems or blocking malicious IP addresses), managing vulnerabilities (e.g., automatically prioritize and schedule patches or system/component updates based on risk severity and impact), compliance monitoring (e.g., automatically monitor compliance with regulatory requirements and internal policies, generating alerts or reports when deviations are detected), incident response automation (e.g., trigger predefined incident response workflows when specific risk thresholds are exceeded, ensuring timely and coordinated actions across teams), model-generated recommendations, such as risk treatment plans (e.g., generate tailored risk treatment plans based on historical data and current risk assessments, recommending specific controls or mitigation strategies), resource allocation (e.g., provide recommendations on optimal resource allocation for risk management activities, such as assigning personnel to high-priority tasks or allocating budget for security investments), predictive risk analysis (e.g., use predictive analytics to forecast potential future risks and recommend proactive measures to prevent or mitigate them) etc., automatically applied security operation actions, such as automatically adjust access control settings based on user behavior analysis, such as revoking access for inactive accounts or tightening permissions for high-risk users), network segmentation (e.g., dynamically segment the network to contain potential threats and limit lateral movement, based on real-time threat intelligence), data encryption (e.g., automatically apply encryption to sensitive data in transit and at rest, based on data classification and risk assessment), anomaly detection and mitigation (e.g., predict anomalies in user behavior or system performance and automatically apply corrective actions, such as throttling suspicious traffic or initiating a deeper investigation), automated reporting and dashboards (e.g., generate real-time dashboards and reports that provide insights into the current risk landscape, enabling stakeholders to make informed decisions quickly), etc.

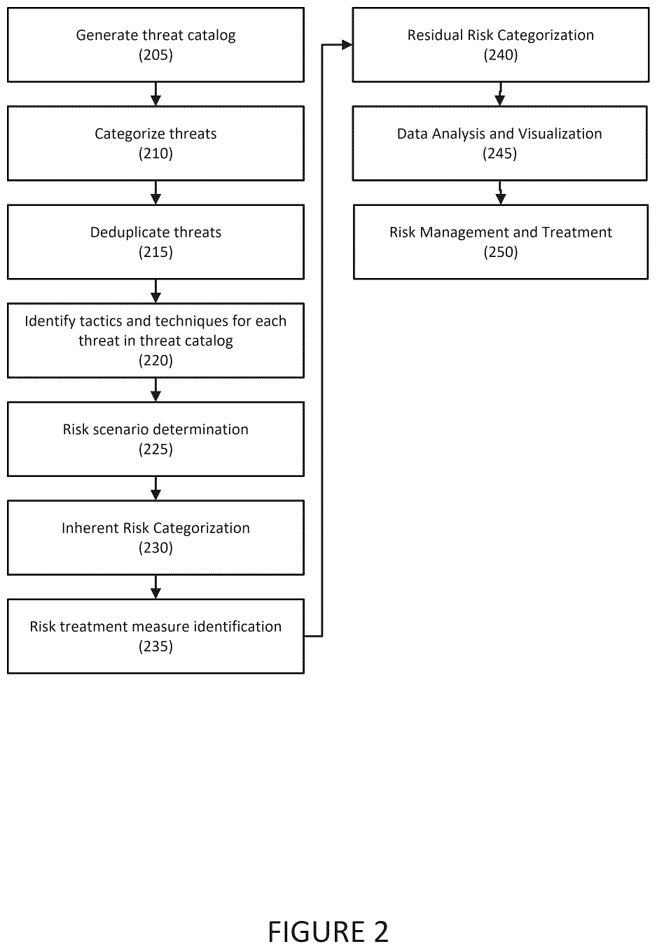

Referring to FIG. 2, a method for large language model based technical risk and architectural analysis is provided according to an embodiment.

In step 205, a threat catalog may be generated. In one embodiment, technical documentation may be received and processed using natural language processing (NLP) techniques. The text may be split into chunks of an appropriate size. Each chunk may be provided to a LLM with a prompt to identify threats in the chunk. An example of a prompt is as follows:
A threat can be defined as: any circumstance or event with the potential to adversely impact organizational operations (including mission, functions, image, or reputation), organizational assets, individuals, other organizations, or the Nation through an information system via unauthorized access, destruction, disclosure, modification of information, and/or denial of service.
Definition of a Good Threat:
Definition of a Good Threat:
1. Clear and Concise Title:
   The title should be short and descriptive, summarizing the core concept of the threat without including implementation specifics.
   Example: “Phishing Attack”
2. Detailed Description:
   The description should provide a clear and detailed explanation of the threat, including how it operates and its potential impact.
   Example: “A cyber-attack in which attackers send fraudulent emails, purporting to be from reputable sources, to trick recipients into revealing sensitive information such as login credentials, or to download malware.”
3. Specific Scope:
   The threat should be a single, clearly scoped entity that does not cross multiple domains or categories. If a threat spans multiple areas, it should be split into separate entries.
   Example: “Insider Threat” should be split into “Insider Data Theft” and “Insider Sabotage.”
4. Actionable Information:
   The threat should include actionable information that can be used to generate risk scenarios and map to MITRE ATT&CK tactics and techniques.
   Example: “Phishing Attack” can be mapped to MITRE ATT&CK techniques such as T1566.001 (Spearphishing Attachment) and T1566.002 (Spearphishing Link).
5. Examples for Clarification:
   Good Example: “Phishing Attack”
   Description: “A cyber-attack in which attackers send fraudulent emails, purporting to be from reputable sources, to trick recipients into revealing sensitive information such as login credentials, or to download malware.”
   Bad Example: “Insider Threat, Excessive Access Exploit, Post-Termination Access, and Post-Termination Access to Third-Party Applications”
   Description: “A disgruntled worker continues to be able to access the firm's systems after leaving the firm, potentially leading to unauthorized access, data breaches, or other malicious activities. Additionally, a malicious insider exploits excessive access to firm systems while at the firm, potentially leading to unauthorized access, destruction, disclosure, or modification of information. Furthermore, a malicious insider exploits excessive access to third-party systems while at the firm, potentially leading to unauthorized access, data breaches, or other malicious activities. Undetected malicious presence transfers high-value information out of the Firm. Internal employee (or malicious actor with foothold internally to the firm's network) sends confidential data externally or pulls down malicious payload for execution within the firm's network propagating malware internally. A threat where a terminated employee retains access to internally hosted applications, potentially allowing them to act on behalf of the organization or access sensitive information. This can lead to unauthorized actions or data breaches. Additionally, a threat where terminated employees retain access to third-party hosted applications, potentially allowing them to act on behalf of the organization or access sensitive information. This can lead to unauthorized actions or data breaches.”

Note that this prompt is exemplary only, and other prompts may be provided as is necessary and/or desired.

In one embodiment, the LLM may return files, such as JSON lists.

Next, in step 210, the threats returned may be categorized. For example, when a threat is identified, the LLM is asked to recursively categorize it according to a threat categorization definition. This significantly reduces the amount of deduplication that is required and improves the reliability of the process: the deduplication is done on the highest-level category only, if threats exist in different categories, it follows that it should not be treated as a duplicate.

In step 215, the threats may be de-duplicated. For example, as new threats are identified, the new threats may be iteratively provided to the LLM with a prompt to determine whether or not the threat is currently represented. This recursively builds a threat catalog starting from an empty one.

In one embodiment, the LLM may be given three options: create a new threat, update an existing threat, or split an existing threat into multiple threats. This approach reduces output tokens, thereby limiting cost, generation times, and context limits.

The LLM may also be prompted to provide an explanation for its decision, which helps understand its reasoning, improve the prompt, and maintain audit trails. Additionally, multithreading may be used to enhance performance by enabling simultaneous queries to the LLM. This results in multiple separate catalogs that are later consolidated into a single deduplicated catalog through sequential processing. This method balances efficiency and accuracy in managing the threat catalog.

An example of a prompt is as follows:
NEW THREAT:
{new_threat}
TASK:
- Analyze the new threat and determine if it is already fully or
partially represented in the threat catalog.
- If the New Threat is not already represented at all in the catalog,
create a new_threat.
- If the New Threat is partially represented, update the existing
representation to include the new details with update_threat.
ENSURE this still fits the description of a GOOD threat. Split if
required.
- If the New Threat is partially represented but updating it will lead
to it becoming a BAD threat, split it into different entries for
clarity with split_threat.

Important Considerations:
Core Concept Matching: Focus on the core concept or essence of the threat. If the new threat's core concept is already represented, consider it as fully represented. Avoid creating new entries for minor differences in wording or additional details.
Similarity Threshold: Minor differences in wording or additional details should not lead to the creation of a new threat if the core concept is the same. If required, update the description of an existing threat to include the additional details.
Synonymous Terms: Recognize synonymous terms and phrases that describe the same threat. For example, “ARP Spoofing” and “ARP Spoofing Attack” should be considered the same threat if their core concepts are identical.
Examples for Clarification:
If “Trojan” is already defined as “A Trojan is malware that masquerades as legitimate software or harmless files. It is often installed through social engineering techniques such as phishing or bait websites. Variants like the Zeus Trojan aim to access financial information and add machines to a botnet,” then a new threat titled “Trojan Attack”

In step 220, each threat in the threat catalog may be tagged with tactics and techniques, such as MITRE tactics and techniques. For example, tactics represent the “why” of an attack technique. They are the adversary's tactical objectives—the reasons for performing an action. Techniques are the “how” adversaries achieve their tactical goals. Each technique describes a specific behavior or method used by attackers. Techniques can sometimes be further broken down into sub-techniques, which provide more detailed descriptions of specific methods.

The LLM may be provided with a detailed breakdown and explanation of the framework and may be asked to identify an objective, a method, and provide an example. Note the example is recorded in the logs but does not get recorded or used anywhere else. This is to force the model to adhere precisely to the instructions given and for debugging/decision insights.

An exemplary prompt is as follows:

Task:
The following is the risk scenario you have been tasked with
classifying:
Scenario Name: {risk_name}
Scenario Description: {risk_description}
You are to identify:
- Objective: What is the adversary trying to achieve? (This aligns
with the tactic)
- Method: How is the adversary achieving this objective? (This
aligns with the technique and possible subtechnique)
- Example: Any specific examples or procedures
Using the scenario description identify which objectives you think
the adversary is trying to achieve
Which methods are they trying to use to achieve this objective

In step 225, a risk scenario may be determined. Risk scenarios are concise statements that outline how an attacker could use given techniques to achieve their objective and exploit a threat under the context of a risk type. Scenarios may be generated on a per threat per risk type basis, but multiple scenarios can be generated per scenario risk type.

For example, given a description of a technology, a use case and an architecture, the computer program may generate potential risk scenarios based on the threat catalog.

An example risk scenario is as follows. For a phishing attack threat, using a T1566.002 Spearphishing Link technique, and a cyber actor foothold risk type, an example risk scenario is “External actors exploit employees lack of awareness to recognize phishing emails by sending a link to a fake login page which is used to capture their credentials. These credentials are then used by the attacker to gain a foothold into the firms' systems.”

Another example of a risk scenario is as follows. For a phishing attack threat, using a T1566.001 Spearphishing Link technique, and a Denial-of-Service risk type, an example risk scenario is “External actors exploit employees lack of awareness to recognize phishing emails by sending a malicious attachment containing a malware payload designed to launch a DDOS attack on the firms network.”

An example prompt to a LLM is as follows:
Produce concise risk scenarios detailing how an attacker could use given techniques to achieve their objective and exploit a threat under the context of a risk type.
Use the following threat grammar structure to determine concise threat scenarios:
[threat source] [prerequisites] can [threat action] which leads to [threat impact], negatively impacting [impacted assets].
Sample statements:
An [internet-based threat actor] [with access to another user's token] can [spoof another user] which leads to [viewing the user's bank account information], negatively impacting [user banking data]
An [internal threat actor] [who has administrator access] can [tamper with data stored in the database] which leads to [modifying the username for the all-time high score], negatively impacting [the video game high score list]
An [internet-based threat actor] [with user permissions] can [make thousands of concurrent requests] which leads to [the application being unable to handle other user requests], negatively impacting [the web application's responsiveness to valid requests].

Now, consider the following details:
Threat:
{threat_title}: {threat_description}
Risk Type Category:
{risk_type}: {risk_description}
MITRE ATT&CK Tactics:
{mitre_tactic}
MITRE ATT&CK Techniques:
{mitre_techniques}
- Use THESE details to determine distinct risk scenarios of how an
attacker could use THE GIVEN techniques to exploit THE GIVEN
threat under the context of this Risk Type Category.
- Ensure to include how the attacker is using the given technique to
achieve their objective and how this relates to the Risk Type
Category.
- Ensure they are relevant to the technology and use case being
assessed.
- Ensure they directly exploit the given threat.
- Of the scenarios identified, return ONLY the ONE that best
represents the information given, that you feel will be of most use
to the reviewer.
- If no risk scenarios are identified, output “No Risk Scenarios
Found”.

Once generated, Risk Scenarios may be treated as a foundational data source in that the rest of the risk assessment is built on top of them on a per scenario basis. This means that it is important that they are accurate. An additional step may be implemented where the generated scenarios are sent back to the LLM for verification. This may be done using the following prompt:

Using the following details:
Threat:
{threat_title}: {threat_description}
Risk Type Category:
{risk_type}: {risk_description}
MITRE ATT&CK Tactics:
{mitre_tactic}
MITRE ATT&CK Techniques:
{mitre_techniques}
A large language model produced the following risk scenario:
{scenario}
Analyze this data and determine if this scenario is directly
applicable to this threat taking into account the given techniques
and risk type. It is important that the scenario directly relates to the
risk type category.
- Output “YES” if the details are correct
- Output “NO” if the details are incorrect
- Explain your reasoning
″″″

The reasoning may be kept in the logs for debugging and analysis purposes as well as forcing the LLM to more precisely relate the content it is generating to the ask but may provide no part in the actual assessment.

In one embodiment, CAPEC tagging may be part of the scenario generation process. CAPEC contains detailed, verified information that is extremely useful when assessing and quantifying the risk of the generated scenarios. This allows to reduce the amount of Red-Amber-Green usage in favor of more concrete data, as well as limiting the LLMs ‘interpretation’ of the question based on its training as the LLM may be provided with better quality data to aid its answering in a more effective way.

An example prompt to the LLM is as follows:

SYSTEM_MESSAGE_TAGGING = ″″″You are a cyber security
expert that has been tasked with identifying the CAPEC Attack
Patterns that correspond to risk scenarios.″″″
PROMPT_CAPEC_TAGGING = ″″″Consider the following
details:
Threat: {threat_title}: {threat_description}
Risk Type Category: {risk_type}: {risk_description}
MITRE ATT&CK Tactics: {mitre_tactic}
MITRE ATT&CK Techniques: {mitre_techniques}
Analyze the following risk scenario that was generated from the
above details:
{scenario}
- Use the details to determine the CAPEC Attack Patterns NAMES
that correspond to the risk scenario.
″″″

In embodiment, the correctness of the CAPEC tags may be validated. One of the problems with relying on the LLM to perform the tagging itself is that there are several versions of the CAPEC framework, some of which are significantly different from each other. It is not clear which version/s were included in the LLMs training, but it is inherently aware of CAPEC but the tags it produces are often aligned to legacy versions. To resolve this, the generated tags back may be related back to a baseline/known truth version of the framework: TF-IDF vectors are created from the ‘name’ field of the generated and source framework tags, and the closest match is returned based on cosine similarity of the vectors.

Once all the tags have been aligned to entries that exist in the known true version of the framework another validation step is completed to ensure that the identified tags are actually relevant to the scenario. This is done using the LLM.

An example of a CAPEC tagging prompt is as follows:

CAPEC attack pattern {id} has been identified by a Large
Language Model as applicable to the following risk scenario:
{scenario}
Here are the details of the attack pattern:
{attack_pattern}
Please verify that this pattern has been correctly identified and that
it makes sense under the context of the risk scenario.
- Respond “YES” if the details are correct
- Respond “NO” if the details are incorrect
- Explain your reasoning

In step 230, the inherent risk may be categorized. Inherent risk is the risk level before any control or mitigations are applied/taken into account. This may involve assessing the possibility of an attack occurring, identifying an impact rating of the severity of the attack if it were to occur, and determining an overall risk rating, which is a combination of the two.

An exemplary rating system is described in NIST SP 800-30 “Guide for Conducting Risk Assessments,”, the disclosure of which is hereby incorporated by reference, and may be defined as follows.
Likelihood: Very Low: The event is very unlikely to occur; Low: The event is unlikely to occur; Medium: The event could occur at some time; High: The event is likely to occur in most circumstances; and Very High: The event is almost certain to occur.
Impact: Very Low: The event would have negligible consequences; Low: The event would cause minor consequences; Medium: The event would cause moderate consequences; High: The event would cause significant consequences; Very High: The event would cause severe consequences.

The combination of Likelihood and Impact are then used to derive the Risk Rating as follows:
Very High Risk: A threat event could be expected to have multiple severe or catastrophic adverse effects on organizational operations, organizational assets, individuals, other organizations, or the Nation.
High Risk: A threat event could be expected to have a severe or catastrophic adverse effect on organizational operations, organizational assets, individuals, other organizations, or the Nation.
Moderate Risk: A threat event could be expected to have a serious adverse effect on organizational operations, organizational assets, individuals, other organizations, or the Nation.
Low risk: A threat event could be expected to have a limited adverse effect on organizational operations, organizational assets, individuals, other organizations, or the Nation.
Very low risk: A threat event could be expected to have a negligible adverse effect on organizational operations, organizational assets, individuals, other organizations, or the Nation.

An example of a prompt to a LLM is as follows:

IMPACT_RUBRIC = ″″″Very Low: The event would have
negligible consequences.
Low: The event would cause minor consequences.
Medium: The event would cause moderate consequences.
High: The event would cause significant consequences.
Very High: The event would cause severe consequences.″″″
LIKELIHOOD_RUBRIC = ″″″Very Low: The event is very
unlikely to occur.
Low: The event is unlikely to occur.
Medium: The event could occur at some time.
High: The event is likely to occur in most circumstances.
Very High: The event is almost certain to occur.″″″
SYSTEM_MESSAGE = ″″″You are a technology risk professional
performing a risk assessment on introducing a new technology into
a large multinational bank. You have been tasked with quantifying
threats identified by a cyber team using NIST rating systems.″″″
PROMPT_TEMPLATE_RISK_ANALYIS = ″″″USECASE/
TECHNOLOGY DETAILS:
{description}
{usecase}
INHERENT RISK ANALYSIS
The specific threat that has been identified as applicable to this
solution is:
{threat_details}
You are to perform a risk analysis on this threat being exploited in
the following scenario:
{scenario}
Below I have included some details from the CAPEC framework
which may be helpful in this analysis:
{capac_summary}

Threat likelihood can be described as: A weighted factor based on a subjective analysis of the probability that a given threat is capable of exploiting a given vulnerability or a set of vulnerabilities. An inherent analysis means the likelihood rating before any controls or mitigations are considered.
Threat impact can be described as the effect on organizational operations, organizational assets, individuals, other organizations, or the Nation (including the national security interests of the United States) of a loss of confidentiality, integrity, or availability of information or an information system. An inherent analysis means the impact and likelihood rating before any controls or mitigations are considered.

Using the following rating system, taken from NIST SP 800-30,
analyze this threat for its likelihood. Choose ONE rating only.
{likelihood_rubric}
and the following rating system analyze this threat for its impact.
Choose ONE rating only.
{impact_rubric}
TASK:
- Analyze the description of the technology that has been provided
- Understand how the given scenario can lead to the exploitation of
the provided threat
- Assess the inherent likelihood of this scenario occurring. Make
use of the provided CAPEC details in your analysis.
- Provided an inherent likelihood rating for the risk scenario
occurring explicitly using the rating system provided
- Provide an explanation as to why this scenario has the inherent
likelihood rating you have assessed as per the rating system
- Assess the inherent impact/ severity of this scenario occurring.
Make use of the provided CAPEC details in your analysis.
- Provided an inherent impact/ severity rating for if the risk
scenario was to occur explicitly using the rating system provided
- Provide an explanation as to why this scenario has the impact
rating you have assessed as per the rating system
″″″

The model performs the analysis and returns its ratings and explanations in the following format:

{“impact” : {“rating”: “Very Low, Low... etc.”, “explanation”:
“short summary of reasoning for rating”},“likelihood” : {“rating”:
“Very Low, Low... etc.”, “explanation”: “short summary of
reasoning for rating”}}

The ratings are then combined to give an overall risk. An example output is included below:

Scenario: An attacker compromises a software component in the AWS SRE supply chain (T1195.002: Supply Chain Compromise: Compromise Software Supply Chain). The compromised software is then deployed within the bank's AWS SRE environment, allowing the attacker to execute malicious scripts (T1059: Command and Scripting Interpreter) to exfiltrate sensitive financial data (Data Exfiltration via Tech).
Threat: Supply Chain Compromise
Inherent Risk:
Impact Rating: Very High
Impact Explanation: The event would cause severe consequences, including unauthorized access to sensitive financial data, potential data breaches, and significant regulatory and reputational damage. Given the nature of the banking industry and the sensitivity of the data involved, the impact of such a compromise would be severe.
Likelihood Rating: Medium
Likelihood Explanation: The event could occur at some time. While AWS has robust security measures, the complexity of the supply chain and the potential for sophisticated attacks targeting software components make this scenario plausible. The CAPEC details indicate that obtaining signing credentials and deploying malicious code is feasible, though not trivial.
Overall Risk Rating: high

In an effort to gain more consistent results, the analysis may be completed multiple times (e.g., 3 or 5) and an average rating is determined. This may be done by taking the modal average impact and likelihood ratings (individually) and may combined using the NIST rating rubric to give an overall risk score.

In step 235, the computer program may identify risk treatment measures (e.g., controls and mitigations) to reduce the inherent risk k (i.e., impact and/or likelihood) of each of the risk scenarios.

Risk treatment measures are identified from multiple sources, both internal and external. Sources may include third party sources, such as MITRE ATT&CK and CAPEC, as well as any other risk and controls taxonomies. For example, during the creation of the threat catalog, the threats were tagged with MITRE Tactics and Techniques. MITRE maintains a list of mitigations for each of its techniques. These are gathered and used in the analysis.

Like MITRE, CAPEC also maintains mitigations for each of its attack patterns. As the risk scenarios have been aligned to CAPEC, we can again pull the aligned mitigations and use these as input for risk treatment identification.

As discussed above, risk scenarios for risk types were generated, and an organization's control objectives may be linked to these risk types.

Once all the relevant mitigations have been pulled from the source data, the LLM may be used to rate their relevance to the scenario. For each scenario, the applicability of the identified controls is assessed, an explanation for each mitigation is provided. This serves two purposes: it acts as a validation/self-checking step so that the LLM can ensure the identified controls make sense, and also gives an indication as to which should be considered for the residual risk analysis.

Applicability of the controls may be determined based on the following: Key (a key control that substantially reduces the risk of the scenario and should be prioritized), Effective (an effective control that reduces the risk of the scenario and should be implemented if possible), Relevant (a relevant control but does not substantially reduce the risk of the scenario), and N/A (the control is not applicable to the scenario). These control ratings, along with the explanations are then recorded against the scenarios but only key controls may then be taken into account when determining the residual risk.

In one embodiment, a robust control effectiveness data source or more reliable way of determining applicability and/or quantifying risk reduction may be used.

In step 240, the computer program may categorize the residual risk, such as an impact and likelihood analysis of the risk scenarios, which may be combined into a residual (after risk treatment) risk score for each scenario. In one embodiment, this may be performed in a manner similar to the way that inherent risk categorization is performed, but it is performed after control and mitigation identification. The inherent analysis, as well as the identified key controls are supplied in the prompt and the same rating system may be used to analyze the residual risk once mitigation steps have taken place.

An example prompt to the LLM is as follows:
TASK:
   Analyze how the identified risk treatment measures can be used to reduce the impact and likelihood of the risk scenario
   Assess the residual likelihood of this scenario occurring: given that the mitigations have been applied.
   Provided a residual likelihood rating for the risk scenario occurring explicitly using the rating system provided
   Provide an explanation for your rating
   Assess the residual impact/severity of this scenario occurring: given that the mitigations have been applied.
   Provided a residual impact/severity rating if the risk scenario was to occur explicitly using the rating system provided
   Provide an explanation for your rating

An example output from the LLM is as follows:
Example Scenario:
Scenario: An attacker uses spearphishing via social media to target a bank employee. They create a fake LinkedIn profile posing as a recruiter from a reputable company and send a message with a link to a fake job application portal. The employee, believing the message to be legitimate, enters their AWS SRE credentials on the fake portal. The attacker captures these credentials and uses them to access the bank's secure remote environment, leading to unauthorized data access.
Threat: Social Engineering Attack
Residual Risk:
Impact Rating: Medium
Impact Explanation: With the implementation of mitigations such as MFA, user training, and network intrusion prevention, the potential consequences of a successful social engineering attack are reduced. However, there could still be moderate consequences if an attacker bypasses these controls.
Likelihood Rating: Medium
Likelihood Explanation: The likelihood of a successful social engineering attack is reduced due to the implemented mitigations, such as user training and anti-phishing measures. However, the possibility of such an attack occurring remains, albeit at a lower probability.
Overall Risk Rating: moderate

In step 245, the computer program may perform data analysis and visualization. For example, the computer program aggregate results, perform thematic gap analysis and/or anomaly identification, gain valuable insights and risk treatment prioritization.

Once the data that forms the risk assessment has been generated, the data may be represented into an interactive visualization. This aggregated view of the risk assessment is useful as the computer program creates many threats, risk scenarios, and risk treatments based on the permutations of CAPEC, MITRE, and risk types, and given the size of the risk assessment produced (large), the thematic insights are valuable to look at. The risk assessment data is stored in a database where the data is linked via relationships (either through the database itself or visualization software). The threat data may be linked to risk scenarios, which can be linked to risk treatment measures.

Embodiments may provide enhanced analytical capabilities, as linking tables enables more complex queries and analyses. Operations, such as joins, aggregations, and filters may be performed across related tables, allowing for deeper insights and more comprehensive visualizations. This capability is essential for creating interactive dashboards that provide a holistic view of the data.

Linked tables may also allow for the creation of interactive dashboards. Users can drill down into specific data points, apply filters, and see how changes in one part of the data affect the rest. For example, selecting a specific category in a chart can dynamically update related charts and tables, providing a more engaging and informative user experience.

For example, a visualization may include a number of threats, scenarios, and risk types impacted across the risk assessment; a total risk reduction, showing how much (in total) risk can be reduced from the risk assessment; a summary of the inherent and residual risk rating of scenarios, showing how the risk reduces from inherent rating to residual rating; a risk register aggregation showing the (1) number of scenarios per risk type, (2) number of risk treatments, (3) total risk reduction per risk type (4) average risk reduction per scenario in a risk type pillar, and (5) the disposition of inherent risk ratings for scenarios per risk type; etc.

As another example, a visualization may provide a heatmap of the risk types versus risk treatments. This is useful as the user can see the mitigations that are most impactful to addressing a particular risk pillar, such as security configuration baseline process, security configuration drift monitoring, and security configuration drift management are risk treatments that correlate well with fixing risk of vulnerability exploit. The visualization may also provide the ability to see overall, the risk treatments that were determined to be (1) key, (2), effective (3) relevant. Additionally, the ability to see the risk treatments sources. Embodiments may also provide heatmaps of the impact and likelihood rating for both inherent and residual risk.

In step 250, the computer program may perform risk management and treatment. For example, the computer program may implement one of the risk treatment measures. To do so, it may determine a risk treatment decision (e.g., accept the risk or apply a fix), document risk and treatment decisions, and monitor risks to closure/validation. For example, the computer program may provide security recommendations such as real-time threat detection and response, managing vulnerabilities, compliance monitoring, incident response automation, model-generated recommendations, such as risk treatment plans, resource allocation, predictive risk analysis. The computer program may also automatically apply security operation actions, such as automatically adjusting access control settings based on user behavior analysis, performing network segmentation, applying data encryption, anomaly detection and mitigation, providing automated reporting and dashboards, etc.

In embodiments, a solution definition may be provided. The solution definition may provide a detailed description of the technology, including what the technology does, how it works, and what it is intended to be used for. In one embodiment, the solution definition may be provided using a template.

In embodiments, data may be collected and prepared. For example, relevant data for the technology may be gathered, cleaned, and formatted so that it may be used to train and/or provide context to the LLM. In one embodiment, the LLM may be used to identify the type of data to be collected.

In embodiments, a model may be trained and/or contextualized. This may train the model and/or provide it with context with the solution definition and gathered data. For example, the model may be contextualized with some, or all of the information provided above. Next, the model may be questioned about the technology and its potential risks. For example, questions like “what are the potential security risks of using quantum key distribution” or “what controls can be put in place to mitigate the risk of IoT devices” may be asked. The model may generate responses based on the context that is provided and the knowledge that it has learned during training.

In embodiments, the responses may be analyzed by a subject matter expert, a user, etc. The responses may also be used as a starting point for additional research.

The training and/or contextualization may be repeated. For example, based on the responses and your analysis, the context may be refined, additional questions may be asked, etc. This iterative process may uncover more detailed and comprehensive information about the risks associated with the technology.

In embodiments, a risk assessment may be generated. For example, the model may be provided with a risk assessment framework, criteria rating, etc. and the model may generate a risk assessment for the technology.

In embodiments, the risk assessment may be reviewed by, for example, subject matter experts. The subject matter experts may validate the findings, provide additional insights, and/or suggest improvements for the model's performance.

This may be an iterative process.

In embodiments, the model may be integrated into the decision-making process. For example, the risk assessments may be used as part of the decision-making process for introducing the new technology. This may include weighing the identified risks against the potential benefits of the technology, considering the proposed risk treatment measures, etc.

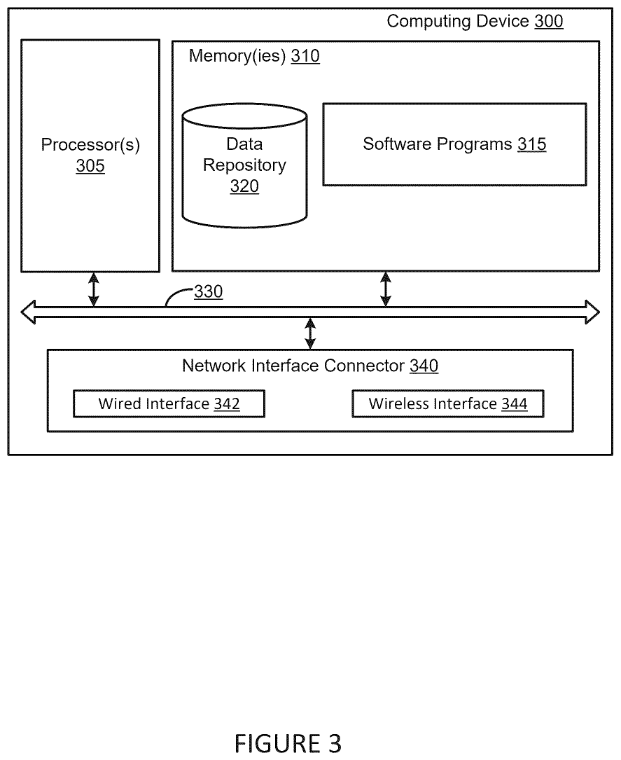

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
generating, by a computer program and using a large language model (LLM), a threat catalog comprising a plurality of threats;
categorizing, by the computer program and using the LLM, the threats into a plurality of threat categories according to a threat categorization definition;
de-duplicating, by the computer program and using the LLM, the threats within each threat category;
determining, by the computer program and using the LLM, based on a description of a technology, a use case, and an architecture, risk scenarios based on the threat catalog;
determining, by the computer program and using the LLM, an inherent risk for each of the risk scenarios;
identifying, by the computer program and using the LLM, risk treatment measures to reduce the inherent risk for each of the risk scenarios;
categorizing, by the computer program and using the LLM, a residual risk for each of the risk scenarios after the risk treatment measures; and
applying, by the computer program, one of the risk treatment measures, based on the residual risk.

2. The method of claim 1, wherein the threat catalog is generated from industry documentation, known risk and migrations, industry standards and best practices, and/or known regulatory requirements.

3. The method of claim 1, wherein the deduplication creates a new threat, updates an existing threat, or splits the existing threat into multiple threats.

4. The method of claim 3, wherein the LLM returns an explanation for creating the new threat, updating the existing threat, or splitting the existing threat into multiple threats.

5. The method of claim 1, wherein each threat in the threat catalog is tagged with a threat tactic and a threat technique.

6. The method of claim 1, wherein each of the risk scenarios is tagged with a Common Attack Pattern Enumeration and Classification tag.

7. The method of claim 1, wherein the inherent risk is based on a likelihood of a risk scenario occurring and an impact of the risk scenario.

8. The method of claim 1, wherein the risk treatment measures are identified from one or more third party source.

9. The method of claim 1, wherein the risk treatment measures comprise security recommendations, managing vulnerabilities, compliance monitoring, and incident response automation.

10. The method of claim 1, wherein the risk treatment measures comprise automatically adjusting access control settings based on user behavior analysis and performing network segmentation.

11. A non-transitory computer readable storage medium, including instructions stored thereon, which when read and executed by one or more computer processors, cause the one or more computer processors to perform steps comprising:
generating, using a large language model (LLM), a threat catalog comprising a plurality of threats;
categorizing, using the LLM, the threats into a plurality of threat categories according to a threat categorization definition;
de-duplicating, using the LLM, the threats within each threat category;
determining, using the LLM and based on a description of a technology, a use case, and an architecture, risk scenarios based on the threat catalog;
determining, using the LLM, an inherent risk for each of the risk scenarios;
identifying, using the LLM, risk treatment measures to reduce the inherent risk for each of the risk scenarios;
categorizing, by using the LLM, a residual risk for each of the risk scenarios after the risk treatment measures; and
applying one of the risk treatment measures, based on the residual risk.

12. The non-transitory computer readable storage medium of claim 11, wherein the threat catalog is generated from industry documentation, known risk and migrations, industry standards and best practices, and/or known regulatory requirements.

13. The non-transitory computer readable storage medium of claim 11, wherein the deduplication creates a new threat, updates an existing threat, or splits the existing threat into multiple threats.

14. The non-transitory computer readable storage medium of claim 13, wherein the LLM returns an explanation for creating the new threat, updating the existing threat, or splitting the existing threat into multiple threats.

15. The non-transitory computer readable storage medium of claim 11, wherein each threat in the threat catalog is tagged with a threat tactic and a threat technique.

16. The non-transitory computer readable storage medium of claim 11, wherein each of the risk scenarios is tagged with a Common Attack Pattern Enumeration and Classification tag.

17. The non-transitory computer readable storage medium of claim 11, wherein the inherent risk is based on a likelihood of a risk scenario occurring and an impact of the risk scenario.

18. The non-transitory computer readable storage medium of claim 11, wherein the risk treatment measures are identified from one or more third party source.

19. The non-transitory computer readable storage medium of claim 11, wherein the risk treatment measures comprise security recommendations, managing vulnerabilities, compliance monitoring, and incident response automation.

20. The non-transitory computer readable storage medium of claim 11, wherein the risk treatment measures comprise automatically adjusting access control settings based on user behavior analysis and performing network segmentation.
